(19) United States
(12) Patent Application Publication
(10) Pub. No.: US 2021/0365745 A1
(43) Pub. Date: Nov. 25, 2021

(54) Method and Apparatus for Implementing Automated Fossil Identification to Augment Biostratigraphy Workflows

(71) Applicant: BP Corporation North America Inc., Houston, TX (US)

(72) Inventor: Emily Browning, Houston, TX (US)

(73) Assignee: BP Corporation North America Inc., Houston, TX (US)

(21) Appl. No.: 17/396,376

(22) Filed: Aug. 6, 2021

Related U.S. Application Data
(60) Provisional application No. 63/063,607, filed on Aug. 10, 2020.

(51) Int. Cl. G06K 9/62; G06K 9/00

(52) U.S. Cl. CPC G06K 9/6268; G06N 3/08; G06K 9/00624; G06K 9/6202

(57) ABSTRACT

A computer program product is embodied on a non-transitory computer readable medium. The computer readable medium has instructions stored thereon that, when executed by a computer, causes the computer to perform receiving image data that is to be recognized by the at least one classifier. The image data captures an occurrence of a fossil species. The computer can also perform generating an output via the at least one classifier based on the received image data. The computer can also perform comparing the output of the at least one classifier with a desired output. The computer can also perform modifying the at least one classifier so that the output of the classifier corresponds to the desired output.

### CROSS-REFERENCE TO RELATED APPLICATIONS

This application claims priority to U.S. Provisional patent application No. 63/063,607, filed with the United States Patent and Trademark Office on Aug. 10, 2020 and entitled “Method and Apparatus for Implementing Automated Fossil Identification to Augment Biostratigraphy Workflows,” the disclosure of which is incorporated herein by reference in its entirety.

### BACKGROUND

The present disclosure relates generally to automated fossil identification.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

One or more embodiments of the present invention is aimed at automation of biostratigraphy fossil detection and classification using artificial neural networks. One or more embodiments can automate the detection, counting, and classification of calcareous nannofossils by using computer vision and deep learning. Biostratigraphy currently relies on manual analysis of a relatively small number of cuttings samples from wells to identify fossil species' occurrence and assemblages to infer relative age and depositional facies (characteristics associated with the environment at the time/location of deposition) of the samples. Automating the process of classifying and counting fossils, along with analysis of greater volumes of material and increased number of samples, provides the possibility to help generate more data faster for subsurface correlations.

One or more embodiment can be developed by a Biostratigraphy Specialist, Data Science specialists from a Data Science Team, and external Biostratigrapher vendors with the appropriate knowledge of fossil taxonomy to create expert labelled datasets. One or more embodiments can be implemented by creating advanced neural network models that are able to accurately produce robust, standardized biostratigraphic datasets to allow machine learning to enhance stratigraphic and sedimentological understanding of the subsurface. To achieve project Proof of Concept, one or more embodiments can utilize both a large and variable training and testing sets derived with high resolution species concepts as to provide accurate measure of objects present. To achieve project Prototype, one or more embodiments can create labeled data and create an end to end workflow that consists of a library of trained data, trained neural networks (NN), and GUI for data visualization. To test the technical validity of one or more embodiments, developers can compare the results of a well analyzed with one or more embodiments to that has been analyzed by of a human. The developers can generate data for a well, and then deploy the pilot in the corresponding region (not at the well site). The data science team can investigate and reuse existing Neural Network Architectures for object detection and libraries YOLO, Retinanet, SSD to design and train models for object detection.

### BRIEF DESCRIPTION OF THE DRAWINGS

Various aspects of this disclosure may be better understood upon reading the following detailed description and upon reference to the drawings in which:

FIG. 1 illustrates a computing system that may perform operations described herein.

FIG. 2 illustrates a method of one or more embodiments of the present invention.

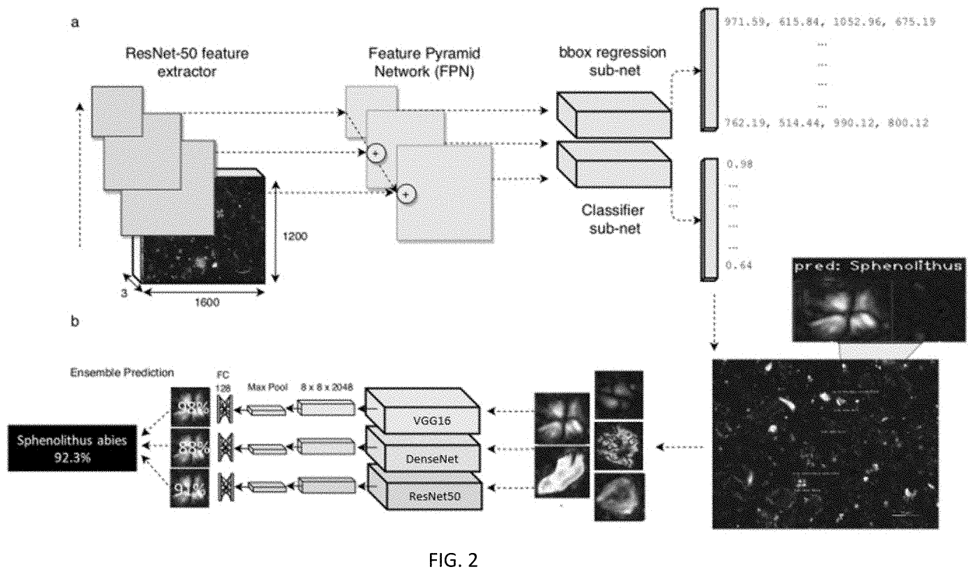

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

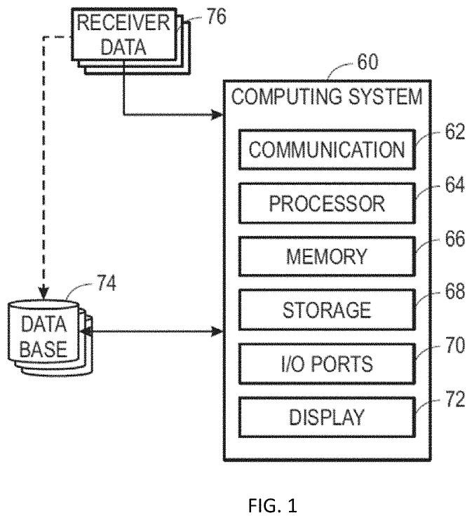

Referring now to FIG. 1, the computing system 60 may include a communication component 62, a processor 64, memory 66, storage 68, input/output (I/O) ports 70, and a display 72. In some embodiments, the computing system 60 may omit one or more of the display 72, the communication component 62, and/or the input/output (I/O) ports 70. The communication component 62 may be a wireless or wired communication component that may facilitate communication between one or more databases 74, other computing devices, and/or other communication capable devices.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. Generally, the processor 64 may execute software applications that include programs that perform automated fossil identification to augment biostratigraphy workflows according to the embodiments described herein.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, input/output (I/O) modules, and the like.

The display 72 may depict visualizations associated with software or executable code being processed by the processor 64. In one embodiment, the display 72 may be a touch display capable of receiving inputs from a user of the computing system 60. The display 72 may be any suitable type of display, such as a liquid crystal display (LCD), plasma display, or an organic light emitting diode (OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process data.

After performing various types of fossil data processing, the computing system 60 may store the results of the analysis in one or more databases 74. The databases 74 may be communicatively coupled to a network that may transmit and receive data to and from the computing system 60 via the communication component 62.

Although the components described above have been discussed with regard to the computing system 60, it should be noted that similar components may make up the computing system 60.

One or more embodiments is directed to a tool that automates biostratigraphy fossil detection and classification. These embodiments can automate the detection, counting, and classification of calcareous nannofossils using computer vision and deep learning.

The collection and tagging of fossil images used for testing and training was obtained from biostratigraphy specialists. The data science team will investigate and reuse existing Neural Network Architectures for object detection and libraries YOLO, Retinanet, SSD to design and train models for object detection.

One or more embodiments of the present invention can provide better stratigraphic resolution, improved ability to discriminate subtle changes in facies, a data science solutions, and a method of data collection.

To implement one or more embodiments of the present invention, a team of biostratigraphers imaged and tagged fossils using the VIA tool from the Oxford Visual Geometry Group (VGG). The annotated images are stored. The data was provided in daily batches, which is how the developers stored it. Each image folder has a corresponding tag folder with the same name. Tags can be stored within VIA project files. If a developer wants to view the original data, the developer would download the VGG Image Annotator (VIA) tool and point it to the image folders and corresponding project folder.

In order to implement one or more embodiments, developers can generate synthetic data. Developers can take the images annotated by the biostratigraphy team and place them on images with different backgrounds. Embodiments of the present invention can aim to get models to ignore any information which is present in the background and focus on the fossil sample in the image.

To implement one or more embodiments, the CocoSynth library can provide helper functions to easily create synthetic datasets in the COCO data format.

Certain embodiments exhibited an improvement in the classifiers, and the developers are currently evaluating it for the whole ensemble.

One or more embodiments of the present invention implement a model that has 2 components a Detector and Classifier.

With regard to the detector, one or more embodiments can use Retinanet for detections. Certain embodiments then crop these images and hand them over to classifiers. One or more embodiments of the invention can use a Fastai implementation of Retinanet.

With regard to classifiers, a classifier is an ensemble of neural networks. One or more embodiments can use Densenet, Resnet and VGG as base architectures and have different loss functions for these. One or more embodiments can use a technique called transfer learning, which involves using pretrained models and fine tuning their weights with our own data. Pretrained models are usually trained on public data, for example images from the web containing cars, dogs and cats.

Classifiers of one or more embodiments of the present invention can produce labels and confidences for each image. One or more embodiments can combine predictions from multiple neural networks into a final prediction by averaging the confidence outputs.

With respect to the use of neural networks, one or more embodiments can use the following models: Resnet50 with Focal Loss, Resnet50 with Label Smoothing Cross Entropy, VGG16 with Ring Loss, and/or Densenet201 with Label Smoothing Cross Entropy. All are model backbones for Densenet, Resnet and VGG are from the Pytorch Model Zoo. One or more embodiments also use the pretrained weights provided by the Pytorch Deep Learning Framework.

Certain embodiments can also use additional techniques for training. These embodiments can be implemented in Fastai, and so the following can be applied to the models: one cycle training, freezing and unfreezing base model, oversampling, and/or data augmentations.

Several academic papers have discussed using image recognition for classification of both calcareous nannofossils and microfossils. For nannofossils, publicly available studies have been successful in genus level identification with a user then to determine the species. The models are trained with statistical data on the morphology of the species and only a small number of images. One or more embodiments of the present invention differ by building a model that will be able to detect and classify all species present within an image by using neural network model built with hundreds to thousands of images in various views to provide model capabilities that rival or exceed manual examination. One or more embodiments will be an industrial application; therefore, it must distinguish and record large numbers of species (150-200 species) to produce data adequate for stratigraphic interpretation. In comparison to published nannofossil studies, one or more embodiments will utilize a much larger image set from multiple locations, that are expert labeled by Biostratigraphers and then possibly use synthetic inputs to improve the model accuracy. To date, no published studies of nannofossil have shown an accuracy high enough to be considered viable for industrial application, though Bollman et al (2002) posit that with a larger data set higher accuracy is possible. One or more embodiments will utilize both a large and variable dataset, thus contrasting previous studies. In addition, the purpose of the model will be to reproduce biostratigraphic zonations over several millions of years. While research on image recognition is well documented in foraminifera research only a few studies have been devoted to nannofossil.

A method of one or more embodiments can include validating a training set. The method can also include data ingestion. The method can also perform a training process to design and train models. Multiple architectures can also be investigated. The method can include evaluating a performance. The method can also include combining multiple models. The method can also include updating a web application.

One or more embodiments can use convolutional neural networks for automated fossil identification. One or more embodiments can explore the application of deep machine learning to augment stratigraphic interpretations.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A computer program product embodied on a non-transitory computer readable medium, said computer readable medium having instructions stored thereon that, when executed by a computer, which implements or operates in conjunction with at least one classifier, causes the computer to perform:
receiving image data that is to be recognized by the at least one classifier, wherein the image data captures an occurrence of a fossil species;
generating an output via the at least one classifier based on the received image data;
comparing the output of the at least one classifier with a desired output; and
modifying the at least one classifier so that the output of the classifier corresponds to the desired output.
